(19) United States
(12) Patent Application Publication
(10) Pub. No.: US 2004/0155023 A1
(43) Pub. Date: Aug. 12, 2004

(54) Stove

(76) Inventors: Karsten Wermbter, Budenheim (DE); Patrik Schober, Mainz-Ebersheim (DE)

Correspondence Address: HARNESS, DICKEY & PIERCE, P.L.C., P.O. BOX 828, BLOOMFIELD HILLS, MI, 48303, US

(21) Appl. No.: 10/726,791

(22) Filed: Dec. 3, 2003

(30) Foreign Application Priority Data
Dec. 5, 2002 (DE) 102 58 727.2-23

(51) Int. Cl. F27D 11/00

(52) U.S. Cl. 219/385; 219/391; 219/541

(57) ABSTRACT

A stove (10) comprising a baking muffle (12) is disclosed. Within the baking muffle (12) guide means (14, 15, 16, 17, 18, 19) for receiving at least one heatable cooking bowl (22) are provided, wherein the cooking bowl (22) comprises a substrate layer, in particular a bottom, at the outside of which a directly heatable heating layer is provided which is coated by an insulating layer (FIG. 1).

### BACKGROUND OF THE INVENTION

The invention relates to a stove having a baking muffle.

The preparation of food in prior art kitchen stoves is generally known. Basically, cooking, baking, stewing, roasting and grilling may be involved. A pipe heater system extending within the upper part as well as within the lower part of the baking muffle is heated to obtain a certain temperature within the baking muffle. For obtaining a more homogenous temperature distribution also a fan may be utilized. However, in many cases the total volume of the baking muffle is not necessary for preparing a particular food. In this case, however, the consumption of energy cannot be reduced, since the baking muffle can only be heated in total.

According to DE 100 59 656 A1, a kitchen stove has become known that comprises a baking muffle within which a height adjustable heatable plate is received.

However, the known design is complicated and requires a high cost.

In case a particular state of roasting shall be obtained, then a grill heater received below the top wall of the cooking stove may be switched on. In case the food shall be roasted on both sides, then it has to be topped over after a certain time. This again results in the loss of energy, since the door of the cooking stove has to be opened.

From DE 41 16 425 A1, a kitchen stove is known that comprises guide means for receiving various heatable cooking vessels. The individual cooking vessels may each contain an electrical radiation heater which can be controlled independently from the heater of the baking muffle. Although in this way basically a more effective energy utilization is made possible when preparing smaller amounts of food, however, the heating of the cooking vessels by radiation heaters or by placing on a heated bottom is not energy effective.

From DE 36 39 872 A1, a device for cooking food utilizing steam or circulated hot air is known that comprises a hot air generator and a steam generator, wherein the lower part of the cooking room is formed by a cooking vessel shaped in the form of a pot, open at the top and which can be individually heated by placing on a separate heated bottom plate. Also such a device is not energy effective.

### SUMMARY OF THE INVENTION

Therefore, it is a first object of the invention to provide an improved stove that allows a high flexibility when preparing food.

It is a second object of the invention to disclose a stove that is very energy efficient.

It is a third object of the invention to disclose a stove allowing a better adjustment to the preparation of various foods by cooking, steaming, baking, stewing, roasting and the like.

According to the invention these and other objects are achieved by a stove comprising a baking muffle within which a guide means is provided for receiving at least one heatable cooking vessel, the cooking vessel comprising a substrate layer carrying at an outer side thereof a directly heatable heating layer, the heating layer being covered by an insulating layer.

The directly heatable cooking vessel can preferably be placed on guide rails located on side walls of the baking muffle.

Thus, the baking muffle can be adjusted to the desired size by inserting a cooking vessel at the desired level. In this way, a very energy effective preparation of food is made possible within the baking muffle. By the direct heating of the cooking vessel, an energy transfer directly to the food is made possible leading to low energy loss. In particular in combination with the assistance of ventilated hot air, tube heaters located in the top region and possibly a grill heater, the cooking, baking or roasting process can be individually adjusted to the respective food to be treated. This leads to a very energy effective preparation of food while reaching the desired characteristics such as a particular state of browning, roasting or broiling.

The insulating layer on the outer side of the cooking vessel serves to avoid thermal radiation losses. Simultaneously, in this way a sufficient electrical insulation is ensured.

According to a further development of the invention, the cooking vessel comprises contacts for electrically contacting the heating layer, the contacts cooperating with contacts provided within the baking muffle.

To this end, contacts may be provided on the lower side of the cooking vessel which cooperate with mated contacts provided on guide rails within the baking muffle.

According to an alternative design, the cooking vessel comprises contact plugs or sockets that cooperate with mated contact sockets or plugs provided at the rear wall of the baking muffle.

In both cases, an electrical connection of the cooking vessel can be simply obtained by inserting the cooking vessel into the guide rails. To this end, the cooking vessel preferably is made of an insulating material, for instance of glass, in particular of borosilicate glass or of a glass ceramic.

In this way prior art baking vessels made of borosilicate glass can be utilized. Merely the application of a heating layer and an insulating layer must be effected in a suitable way.

Preferably, the heating layer consists of a layer deposited from a gas phase, in particular by sputtering, by CVD or by PVD. Also the heating layer may be a layer deposited by spraying pyrolysis, or according to a particularly preferred embodiment, the heating layer may be a thermally sprayed layer.

When utilizing these processes, various layers may be deposited with the desired thickness. While sputtering, CVD, PVD or spraying pyrolysis usually lead to thin layers on the order of about 0.5 to 5 μm that are necessary for thin film heating, a thermal spraying allows for a cost effective application of thicker layers on the order of 5 to 100 μm. In particular, atmospheric or vacuum plasma spraying, cold gas spraying, flame spraying or light-arc spraying may be utilized as thermal spraying processes.

The heating layer material may be any material suitable for this purpose. This includes metallic layers, such as NiCr based alloys or FeCr based alloys. Also alloys having a low thermal expansion, such as Invar® or Kovar® are suitable. Using a spraying pyrolysis process preferably metal oxides may be applied, such as tin oxide (SnO₂) doped with Ce, La, Sb or Zn. All the afore-mentioned layers may be applied by thermal spraying in a cost effective way.

Between the substrate layer and the heating layer preferably a coupling layer is provided which may be an aluminum oxide layer, a mullite layer or a cordierite layer.

In this way the differences between the coefficients of thermal expansion that exist between the basically metallic heating layer and the substrate layer preferably consisting of glass or a glass ceramic, can be tolerated in a better way.

In addition, it is possible to lower the coefficient of a thermal expansion of the heating layer by admixing filler materials, such as glass particles, that have a lower coefficient of thermal expansion. In this way, a better matching to the lower coefficient of thermal expansion of the substrate layer may be reached.

Also it is possible to utilize an electrically conductive paste having a high metallic content for depositing the heating layer. The paste may, in particular, comprise silver and can be applied by a suitable process, such as screen printing.

Depending on whether a thick film heater or a thin film heater is utilized, the heating layer may preferably have a layer thickness between about 5 and 100 μm, preferably between about 10 and 60 μm (thick film heater), or may have a layer thickness between about 0.5 and 20 μm, preferably between about 0.5 and 5 μm (thin film heater).

The insulating layer preferably consists of a ceramic. To this end, in particular ZrO₂ is suitable, due to its thermal insulating characteristics. Possibly also Al₂O₃ may be used.

According to a preferred development of the invention, the insulating layer is, in addition, covered by a top layer.

Herein the top layer preferably is a diffusion impeding layer that may consist of an organic silicon based lacquer or that may consist of an inorganic lacquer comprising dispersed metal oxide particles. This layer serves to protect against chemical attack or against humidity (oxidation). The layer may be applied by a suitable application process, such as by spraying or dipping. The layer thickness preferably is about 10 to 50 μm.

Thus, the complete system of a cooking vessel comprising a heating layer, an insulating layer and a top layer is very compact and can be placed in a dishwasher for cleaning.

In case the maximum heating power is limited in a suitable way, thus limiting the maximum temperature at the inner wall of the cooking vessel, then the inner wall may be protected by an anti-sticking material, such as PTFE.

Preferably, the cooking vessel is designed as a bowl that is matched in its size and shape to the cross-section of the baking muffle. In addition, a suitable top or cover may be placed on the cooking vessel. Also the top may comprise a direct heater in a similar manner.

This allows to utilize different combinations of cooking bowls or tops simultaneously within the baking muffle.

It will be understood that the above-mentioned and following features of the invention are not limited to the given combinations, but are applicable in other combinations or taken alone without departing from the scope of the invention.

### BRIEF DESCRIPTION OF THE DRAWINGS

Further features and advantages of the invention will become apparent from the following description of preferred embodiments taken in conjunction with the drawings.

FIG. 1 shows a kitchen stove according to the invention shown with open door in schematic representation.

FIG. 2 shows a cross-sectional view of a cooking vessel shaped in the form of a bowl according to FIG. 1, shown in enlarged representation.

FIG. 3 shows a partial cross-sectional view through a bottom of the cooking vessel according to FIG. 2, shown in enlarged representation.

FIG. 4 shows a modification of the bottom according to FIG. 3, wherein an additional top layer is applied onto the insulating layer.

FIG. 5 shows a cooking bowl according to FIG. 2 on top of which a cover or top has been placed that is also directly heatable.

### DETAILED DESCRIPTION OF THE PREFERRED EMBODIMENTS

In FIG. 1, a stove designated in total with reference numeral 10 is shown schematically after the door has been opened. The stove 10 comprises a baking muffle 12 with tube heaters 27, 29 located at the bottom and top side thereof.

The stove 10 basically may be operated in a known manner like any kitchen stove known in the prior art. Thus, it may be operated while selectively utilizing the top and/or wall and/or bottom heaters and/or a grill heater. Also a blower preferably located at the rear wall (not shown) may be utilized.

However, in addition the stove according to the invention comprises guide rails 14, 15 and 16, 17 and 18, 19, respectively, which are located at the side walls of the baking muffle at about even intervals. On these guide rails 14, 15, 16, 17, 18, 19 a cooking vessel taking the form of a cooking bowl can be received at different levels. According to the embodiment shown in FIG. 1, three different levels are possible.

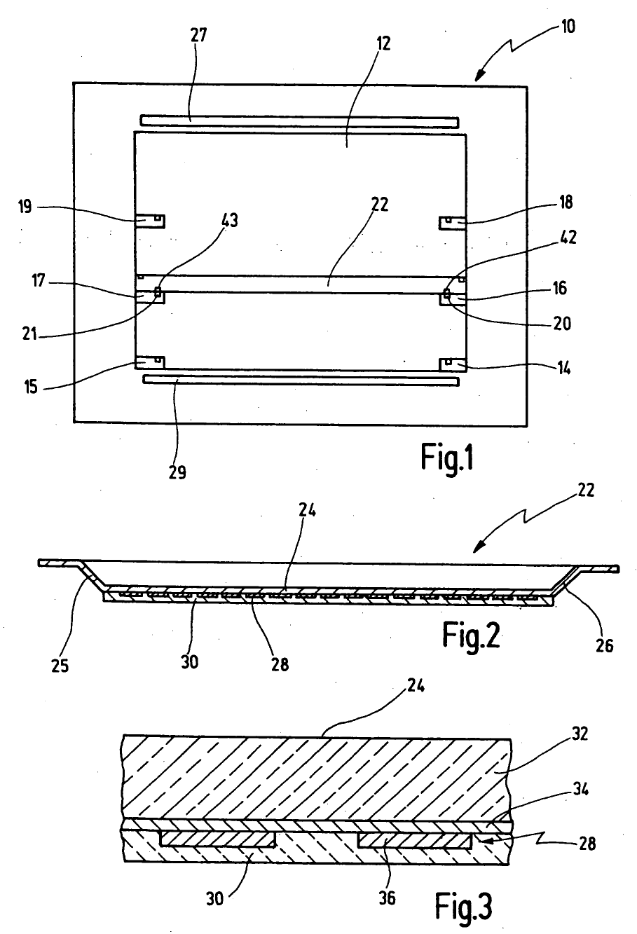

The cooking vessel 22 comprises a direct heater having an insulated heating layer applied onto the bottom of the cooking vessel 22 (cf. FIGS. 2 to 4). To effect electrical power supply, the cooking vessel 22 comprises contacts 42, 43 at its lower side which may, for instance, be configured as contact rails made of a material of good electrical conductivity, such as copper. These contacts 42, 43 cooperate with suitable contact inserts 20, 21 located on the upper side of the guide rails 14, 15, 16, 17, 18, 19.

Alternatively, the electrical power supply may be effected by suitable contact plugs or sockets located at the rear wall cooperating with suitable sockets or plugs at the rear side of the cooking vessel 22 (not shown).

When operating the stove 10 with one or more cooking vessels 22, then the heater 29 at the bottom side preferably is switched off, so that the cooking vessels 22 are merely heated by their integrated direct heaters and by the heater 27 at the upper side of the stove. Possibly also a grill heater (not shown) located at the inner side of the baking muffle 12 may be switched on.

As can be seen from FIG. 2, the cooking vessel 22 may be designed as a flat bowl having side edges protruding to the outside and being designed as guides that rest against the side walls of the baking muffle 12 while keeping a certain play. Cooking vessel 22 consists of a substrate made of an insulating material, such as glass, in particular borosilicate glass, or a glass ceramic. For instance, the cooking vessel may be a baking bowl made of borosilicate glass or of glass ceramic of conventional design that is, additionally, coated at the bottom 24 with a heating layer 28 and an insulating layer 30. As can be seen from the enlarged representation according to FIG. 3, a coupling layer 34 is provided, which may consist of aluminum oxide, mullite or cordierite, between the substrate layer 32 consisting of borosilicate glass and between the heating layer 28. On the lower side of the coupling layer 34 a heating layer 28 is located which consists of heating layer paths 36 that are arranged in a suitable way.

The coupling layer 34 and the heater paths 36 are preferably applied by thermal spraying. Thereafter onto the lower side of the heating layer 28 an electrically and thermally insulating insulation layer 30 is applied which is also preferably performed by thermal spraying. The heating layer preferably consists of a nickel chromium based alloy or of a iron chromium based alloy. The insulating layer 30 preferably consists of zirconium oxide, however, may also consist of aluminum oxide or of other insulating materials. Preferably, the coupling layer 34 is a thin thermally sprayed layer having a layer thickness of about 0.5 to 10 μm. The heating layer has a layer thickness between about 10 and 60 μm (thick film heating layer) or between about 0.5 and 5 μm (thin film heating layer). The design is selected in such a way that maximum temperatures of about 350° C. can be reached on the inner side of the cooking vessel.

In case the maximum heating power is limited in a suitable way, so that a lower maximum temperature can be reached at the inner side of the cooking vessel, then the inner side may, in addition, be coated with an anti-sticking layer, such as a PTFE layer.

The insulating layer 30 serves for heat insulation to the outer lower side, for electrical insulation as well as a mechanical protection of the heating layer. The layer thickness is about 10 to 100 μm.

As can be seen from FIG. 4, in addition a top layer 38 may be applied onto the outer side of the insulating layer 30 serving as a diffusion impeding layer. The top layer 38 serves for protection against chemical attack and attack by moisture (oxidation). To this end organic silicon based lacquers or inorganic lacquers comprising dispersed metal oxide particles may be applied by suitable application processes such as spraying or dipping. The layer thickness is about 10 to 50 μm.

In the design according to FIG. 4, the total thickness of the bottom 24′ including a glass substrate layer 32, coupling layer 34, heating layer 28, insulating layer 30 and top layer 38 is very small (it should be noted that in the drawings the layer thickness of coupling layer 34, heating layer 28, insulating layer 36 and top layer 38 was considerably enlarged when compared with the substrate layer 32).

The cooking vessels may be cleaned by placing in a dishwasher without any problem.

It will be understood that when applying individual layers by thermal spraying (e.g. by atmospheric or vacuum plasma spraying, flame spraying or light-arc spraying) the surface layer is cleaned and sandblasted in a suitable way in the very beginning. The process parameters during layer application are not discussed here, since thermal spraying is generally known in this regard.

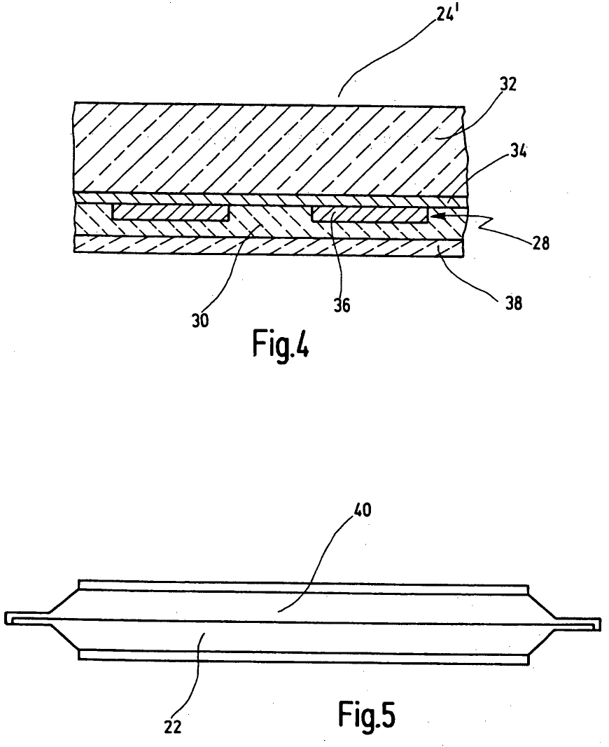

In addition, in FIG. 5 it is shown that a cooking vessel 22 being designed as a bowl may cooperate with a cooking vessel 40 which is formed as a top or cover, thus together forming a complete unit closed against the outside. Also the top or cover 40 may in a similar way comprise a heating layer, an insulating layer and a top layer.

In this way, several individual foods may be prepared within the baking muffle independently from each other, since in each individual module an individual temperature suitable for the respective food may be obtained.

What is claimed, is:

1. A stove comprising:
a baking muffle having a top wall, a bottom wall, a rear wall and two side walls;
a plurality of guide rails located an said side walls at different levels above each other for holding and guiding at least one heatable cooking vessel at a selected one of said levels; and
electric contacts provided within said baking muffle;
said cooking vessel comprising:
a bottom made of a material selected from the group formed by glass and a glass ceramic, said bottom having an outer surface;
a directly heatable heating layer applied to a selected part of said bottom;
an insulating layer covering said heating layer;
a coupling layer arranged between said substrate layer and said heating layer;
a diffusion impeding top layer covering said insulating layer, wherein said top layer consists of a material selected from the group formed by an organic silicon based lacquer and by an inorganic lacquer comprising dispersed metal oxide particles; and
contacts that cooperate with said electric contacts provided within said baking muffle for providing power supply to said cooking vessel.

2. A stove comprising
a baking muffle;
a plurality of guides located at different levels within said baking muffle for holding and guiding at least one heatable cooking vessel at a selected one of said levels; and
electric contacts provided within said baking muffle;
said cooking vessel comprising:
a bottom made of a material selected from the group formed by glass and a glass ceramic, said bottom having an outer surface;
a directly heatable heating layer applied to a selected part of said bottom;
an insulating layer covering said heating layer; and
a top layer covering said insulating layer;
contacts that cooperate with said electric contacts within said baking muffle for providing power supply to said cooking vessel.

3. The stove of claim 2, further comprising a plurality of guide rails located on side walls of said baking muffle for receiving cooking vessels at different levels.

4. The stove of claim 2, wherein said cooking vessel further comprises first contacts for electrically contacting said heating layer, said first contacts cooperating with second contacts provided within said baking muffle.

5. The stove of claim 2, wherein said cooking vessel is made of a borosilicate glass.

6. The stove of claim 2, wherein said cooking vessel is made of a glass ceramic.

7. The stove of claim 2, wherein said heating layer is configured as a layer deposited from a gas phase.

8. The stove of claim 2, wherein said heating layer is configured as a layer deposited by a process selected from the group formed by sputtering, chemical vapor deposition, physical vapor deposition, spraying pyrolysis and thermal spraying.

9. The stove of claim 2, wherein said heating layer comprises a material selected from the group formed by a nickel chromium based alloy, an iron chromium based alloy, and a metal oxide.

10. The stove of claim 2, wherein said heating layer comprises a material selected from the group formed tin oxide doped with at least one component selected from the group formed by cerium, lanthanum, antimony and zinc.

11. The stove of claim 2, further comprising a coupling layer arranged between said substrate layer and said heating layer.

12. The stove of claim 2, wherein said coupling layer comprises a material selected from the group formed by aluminum oxide, mullite and cordierite.

13. The stove of claim 2, wherein said heating layer has a thickness between 5 and 100 micrometers.

14. The stove of claim 2, wherein said heating layer has a thickness between 10 and 60 micrometers.

15. The stove of claim 2, wherein said heating layer has a thickness between 0.5 and 20 micrometers.

16. The stove of claim 2, wherein said heating layer has a thickness between 0.5 and 5 micrometers.

17. The stove of claim 2, wherein said insulating layer comprises a material selected from the group formed by zirconium oxide and aluminum oxide.

18. The stove of claim 2, further comprising a top layer covering said insulating layer.

19. The stove of claim 18, wherein said top layer is configured as a diffusion impeding layer.

20. The stove of claim 18, wherein said top layer is made of a material selected from the group formed by an organic silicon based lacquer and by an inorganic lacquer comprising dispersed metal oxide particles.

21. The stove of claim 18, wherein said top layer has a thickness between 5 and 100 micrometers.

22. The stove of claim 21, wherein said top layer has a thickness between 5 and 50 micrometers.

23. The stove of claim 2, wherein said cooking vessel comprises an anti-sticking layer.

24. The stove of claim 23, wherein said anti-sticking layer comprises PTFE.

25. The stove of claim 2, wherein said cooking vessel comprises a lower side carrying contacts that cooperate with mated contacts provided on guide rails within the baking muffle for providing power supply to said cooking vessel.

26. The stove of claim 2, wherein said cooking vessel comprises a contact plug cooperating with mated contact plugs provided at a rear wall of said baking muffle.

27. The stove of claim 2, wherein said heating layer is made of an electrically conductive paste having a high metallic content.

28. The stove of claim 27, wherein said heating layer is a screen printed layer made of a paste comprising silver.

29. The stove of claim 2, wherein said cooking vessel is configured as a bowl.

30. The stove of claim 2, wherein said cooking vessel is configured as a cover designed for covering a bowl.

31. In a stove comprising a baking muffle within which a guide means is provided:
a cooking vessel for receiving food, comprising
a bottom having an outer surface;
a heating layer provided on said outer surface;
a directly heatable heating layer applied to said outer surface;
an insulating layer covering said heating layer; and
electric contact means for electrically connecting said heating layer to an external power supply.

32. A cooking vessel for receiving food, comprising
a bottom having an outer surface;
a heating layer provided on said outer surface;
a directly heatable heating layer applied to said outer surface;
an insulating layer covering said heating layer; and
electric contacts for electrically connecting said heating layer to an external power supply.
